(19) United States
(12) Patent Application Publication
(10) Pub. No.: US 2009/0172745 A1
(43) Pub. Date: Jul. 2, 2009

(54) Method and Apparatus Regarding Receipt of Audio-Visual Content Information and Use of Such Information to Automatically Infer a Relative Popularity of That Content

(75) Inventors: Tzvetan T. Horozov, Hoffman Estates, IL (US); Danesh S. Irani, Atlanta, GA (US); Swapnil E. Mhatre, Atlanta, GA (US); Nitya Narasimhan, Lake Zurich, IL (US); Venugopal Vasudevan, Palatine, IL (US); Joseph F. Wodka, Hoffman Estates, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/965,843

(22) Filed: Dec. 28, 2007

(51) Int. Cl. G06F 3/00

(52) U.S. Cl. 725/61

(57) ABSTRACT

A network element (200) receives (101), from a plurality of different end users (205), information regarding content clips as pertain to audio-visual content and uses (102) that information to automatically infer a relative popularity of audio-visual content as corresponds to the content clips to provide popularity information. Such audio-visual content can comprise, for example, televised content. The aforementioned information can comprise, for example, such items as a start time and a stop time for a given one of the content clips, at least a portion of a given one of the content clips, a content identifier of some kind, and so forth.

### TECHNICAL FIELD

This invention relates generally to audio-visual materials.

### BACKGROUND

Audio-visual materials of various kinds are known in the art and include, for the purposes of these discussions, streaming content of various kinds including television broadcasts (via licensed television broadcast channels, satellite transmissions, cable networks, and so forth) and packet data-based stream (such as streams that are provided via the Internet). Such materials are becoming available via an increasing number of channels and modalities. This, in turn, is leading to an increasingly large quantity of widely varying materials that are available to the average end user.

The relative quality of such material, however, varies widely. The end user behavior known as channel surfing may simply reflect an unsatisfied suspicion on the part of a given viewer that their viewing time might be better spent watching something other than what they are presently viewing. Various available viewing guides exist in some settings to try and address this need by providing a potential end user with selected metadata regarding a given item of audio-visual content. Such information, however, often becomes available (if at all) only after some considerable period of time measured in days if not weeks, months, or even years following some initial airing of that content.

Furthermore, such metadata, to the extent it has value, usually best applies to content that has already been broadcast. The existing view-and-review paradigm offers little of value to an end user who is wondering what might be worth watching at this very moment when the opportunities include, for example, live content (such as a sports event, an awards program or other live performance, and so forth) that just happens to have become an excellent program to view at that moment. Being the ignorant participant in the next day's proverbial water cooler discussion about an excellent program from the pervious evening's programming is often how a typical viewer of today learns of what they should have been watching in place of what they were watching.

### BRIEF DESCRIPTION OF THE DRAWINGS

The above needs are at least partially met through provision of the method and apparatus regarding receipt of audio-visual content information and use of such information to automatically infer a relative popularity of that content described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network element receives, from a plurality of different end users, information regarding content clips as pertain to audio-visual content and uses that information to automatically infer a relative popularity of audio-visual content as corresponds to the content clips to provide popularity information. Such audio-visual content can comprise, for example, televised content. The aforementioned information can comprise, for example, such items as a start time and a stop time for a given one of the content clips, at least a portion of a given one of the content clips, a content identifier of some kind, and so forth.

Such popularity information can serve various useful purposes. By one approach, for example, the popularity information can serve to form viewing recommendations. Such viewing recommendations can then be provided to at least some of the plurality of different end users. By one approach, this can comprise providing a viewing recommendation for a first currently delivered viewing opportunity to an end user who is presently viewing a different viewing opportunity. This, in turn, avails the end user of an opportunity to make a viewing correction during the original broadcasting of the source programming.

As another example, this popularity information can serve to aid in determining a price for advertising to be aired in conjunction with a selected item of audio-visual content. As one illustration in this regard, this can comprise providing the popularity information to potential advertisers and receiving bids from the potential advertisers regarding a price to be paid to air an advertisement in conjunction with the selected item of audio-visual content. By this approach, for example, advertising rates for a programming transmission that is succeeding in attracting considerable present attention can be dynamically altered in a way that reflects the increased dissemination opportunities being offered to the advertisers.

So configured, those skilled in the art will appreciate that numerous advantages over prior practices in this regard are realized. The so-called wisdom of the mob is readily captured in at least near time if not literal real time and leveraged in a way that is advantageous to both the end users, the broadcasters, and the advertisers who often support the costs of providing such transmissions. These teachings are highly scalable and are likely to provide increasing benefits as the number of channels and programming opportunities grows ever larger going forward. These teachings are also reasonably implemented using existing platforms hence making these solutions economically viable in practice.

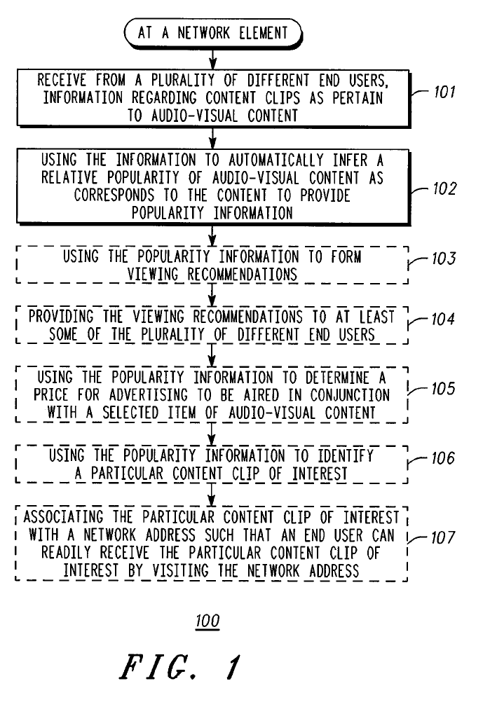

These and other benefits may become clearer upon making a thorough review and study of the following detailed description. Referring now to the drawings, and in particular to FIG. 1, an illustrative process that is compatible with many of these teachings will now be presented. In this illustrative example, it will be presumed that the described actions are occasioned by an appropriate network element. Further examples in this regard will be provided below.

This process 100 provides for receiving 101, from a plurality of different end users, information regarding content clips as pertain to audio-visual content. Those skilled in the art will recognize that a variety of possibilities exist with respect to this audio-visual content. Examples include, but are not limited to, recorded content such as audio-visual content that is distributed via video tape cassettes, digital video discs, or digital memory, televised content recorded using a personal video recorder (PVR), and so forth. Other examples might include streaming content as accessed via a digital network such as the Internet (including, by way of a specific non-limiting example, audio-visual clips as are available via a service such as You Tube). For the sake of simplicity and ease of explanation in this example, it will be presumed that this audio-visual content comprises televised content (understanding, again, that televised content can comprise content that is transmitted via a nationally licensed television radio frequency channel, via a nationally licensed television content satellite channel, via an Internet-based television content delivery system and/or via a cable television system).

The information itself can comprise any of a variety of possibilities as well. Relevant examples include a start time for a given one of the content clips, a stop time for a given one of the content clips, a duration time for a given one of the content clips, a content identifier for a given one of the content clips (such as a title, a serial number, or the like), and/or at least a portion of a given one of the content clips itself (as may or may not be also accompanied by corresponding metadata regarding the content clip and/or the source content itself).

Such information can also comprise, if desired, tagging information regarding such a content clip. In accordance with well understand practice in this regard, tagging information can comprise characterizing information as may be provided by the end user themselves. This can include, by way of a simple example, characterizing expressions such as “funny,” “exciting,” “violent,” “beautiful,” and so forth. Tagging information can also include objective content such as the name of persons who are viewable in the content clip, brief descriptions of the subjective content of the content clip, and so forth.

This step of receiving 101 such information can be accomplished in any of a wide variety of ways. In a case where a given end user has digital video recorder capabilities, the end user can, upon viewing some particular content of interest, pause and reverse/forward to mark the beginning and ending of the content of interest and then use a messaging capability to communicate that information to the aforementioned network element. And, again, that message can comprise information such as the channel that bears the content of interest along with the start and end times of the clip itself. This message can also comprise, as is also noted above, the audio-visual clip itself (either at the original resolution or in some compressed form as desired). As many digital video recorders also provide the capability to backup during a live broadcast and view previously watched content, it only requires a modest alteration, well within the skill set of the average artisan in this field, to permit the aforementioned identification of a clip of interest and the transmission of such content to the network element.

Such a message can be conveyed to the network element using any of a variety of known technologies. In many cases, such information can likely be easily and readily conveyed via the Internet through use of an 802.11-compatible transmission platform of choice. Those skilled in the art will recognize and appreciate that the precise technology selected in this regard can comprise a function of the needs and/or opportunities as are presented in a given application setting. For example, when the end user platform comprises a cellular telephone having audio-visual content rendering capabilities, such information can be conveyed using the cellular telephony capabilities of the end user platform itself. Various approaches are known in the art in this regard. As these teachings are not overly sensitive to any particular selection in this regard, for the sake of brevity and the preservation of clarity, further elaboration in this regard will not be presented here.

As noted, this step of receiving 101 the information can comprise, if desired, receiving the audio-visual clip itself. By one approach, this can comprise having the end user platform itself transmit such information. In many application settings, however, this may be impractical for any of a variety of reasons (including transmission bandwidth limitations, power conservation requirements, and so forth). By another approach, as when the end user only provides enough information to identify the clip but without the clip itself, this can comprise receiving at least some of the audio-visual content of interest from a tuner farm. Such a tuner farm can comprise a facility (or facilities) having, in most cases, a plurality (and likely a relatively large number, such as thousands) of tuners that are, in turn, provided with access to one or more content feeds of interest (such as, but not limited to, various television broadcasting networks, Internet broadcasters, and so forth).

When working with a tuner farm, for example, the network element can forward some or all of the clip-identifying information as has been provided by the end user to the tuner farm to thereby permit the latter to extract the clip from already-recorded audio-visual content. By one approach, the individual elements of such a tuner farm can operate, more or less, as consumer digital video recorders. So configured, such a recorder might serve to retain recorded content for no more than, say, thirty minutes. In such a case, all requests for clips gleaned from a given broadcast can be honored so long as those requests arrive within that thirty minutes.

Given that the tuner farm resides separately from the source of the content received at each client, it is possible that the content feeds received by the user may be offset by a number of seconds with respect to the content feeds received at the tuner farm. For instance, the same content (such as a CNN broadcast) may reach the tuner farm and the client at slightly different times due to network delays (for example, when the tuner farm monitors CNN via a satellite link while the client uses a cable subscription). Such lack of exact temporal synchronization between the tuner farm and the client may result in creating a clip that has different start and stop times than what the user intended. To resolve such issues, the tuner farm and the client an employ a protocol that uses certain features of the content (such as, for example, commercial breaks) to determine a correct timing offset between the tuner farm and the client device for the purpose of creating a clip that matches the specifications provided by the user. A possible implementation of that protocol may be to create histograms of the commercial breaks (one at the farm and one at the client) and then align such histograms to determine the content time offset between the client and the tuner farm.

This process 100 then provides for using 102 the information to automatically infer a relative popularity of audio-visual content as corresponds to the content clips to provide popularity information. Such popularity can be relative in either of at least two ways—the popularity of a given content clip can be gauged relative to some static standard (such as the number of clip reference messages as have been received from all end users for this particular clip as compared to some specific threshold value, such as 100,000 end users, 1,000,000 end users, or the like) or the popularity of a given content clip can be gauged relative to other content clips.

As to the latter, for example, three clips may represent the three clips that have received a greatest number of corresponding clip submissions over some period of time (such as a most current one minute, five minutes, ten minutes, one hour, one day, or the like). The first clip may have received, for example, 128,341 submissions from corresponding end users, the second may have received 57,902 submissions, and the third 33,390 submissions. The first clip can be viewed, in such an example, as being the most currently popular clip relative to all other candidate clips and these three clips, in the aggregate, can be viewed as being the three most currently popular clips relative to all other candidate clips. Such a relative ranking can change, of course, from moment to moment as the network element continues to receive new content clip submissions.

Other possibilities are of course possible. For example, by one approach, relative popularity of a given item of audio-visual content can be judged, in whole or in part, upon how many content clips are received for that item regardless of whether such content clips represent a same, or a different, portion of that item of audio-visual content. Numerous different identified content clips for a given item of audio-visual content can comprise an indication, for example, that the item of audio-visual content contains a wealth of material that is worth viewing as versus only a single highlight of interest.

This resultant popularity information can serve a variety of follow-on purposes. By one option, for example, this process 100 will accommodate using 103 this popularity information to form viewing recommendations. By one approach, this recommendation can comprise a recommendation to view a particular clip that has been noted and submitted as described above. By another approach, this recommendation can comprise a recommendation to view a program from which the particular clip itself was extracted. In such a case as this, the recommendation can specifically comprise a recommendation to watch a remaining portion of this program as may still be being broadcast following the particular clip. Note that the audio-visual content clip may have been generated on one device (such as a set top box) and then recommended to a user on a second device (such as a mobile platform). In this case, the network element can also ensure that the recommendation refers to a transcoded version of the content clip that is compatible with the second device. In such a case, the recommendation may now conditionally comprise a recommendation to watch the whole (or remaining portion of) the program if a compatible version of that program exists for the second device.

This process 100 can then also optionally provide for providing 104 such a viewing recommendation to at least some of the plurality of different end users and/or other potential content consumers. By one approach, this can comprise providing such a viewing recommendation in at least near time with respect to a transmission of the audio-visual content to which the viewing recommendation pertains (where, as used herein, “near time” will be understood to refer to a recommendation that is provided at a time when the audio-visual content is still being originally transmitted notwithstanding that the particular content clip portion of that audio-visual content which instigated the recommendation itself is completed and is no longer being transmitted). This, in turn, can provide an end user with the opportunity to purposefully begin viewing the recommended item in reliance upon this recommendation.

This, in turn, can also comprise, if desired, providing such a viewing recommendation for a first currently delivered viewing opportunity to an end user who is otherwise presently viewing a different viewing opportunity. This approach will give the end user the option and opportunity to begin viewing the recommended viewing opportunity in lieu of their presently viewed opportunity.

Such a recommendation can be delivered to the end user(s) using any of a wide variety of delivery technologies. By one approach the recommendation can be provided via the primary carrier of the end user's audio-visual content receiver. For example, when the end user uses a television receiver, such a recommendation can be provided (for example, by a CATV or satellite-based service provider) as an alphanumeric information crawl at the bottom of the display screen. By another approach, if desired, such recommendations can be delivered using an alternative modality. For example, such a recommendation can be delivered as a text message to a cellular telephone for the end user.

These teachings will also accommodate using 105 the popularity information to determine a price for advertising to be aired in conjunction with a selected item of audio-visual content. As but one illustration in this regard, and without intending any limitations by this example, this can comprise providing the popularity information to potential advertisers and then receiving bids from the potential advertisers regarding a price to be paid to air an advertisement in conjunction with the selected item of audio-visual content. Such a process can be readily automated and facilitated using, for example, a communication medium such as the Internet. So configured, for example, a one hour television program that is being viewed as “popular” during its broadcast as per the teachings set forth herein can demand, and receive, higher fees for advertisements that are shown during a latter portion of that broadcast program by advertisers who have waited for such confirmation that their advertisements are likely to be viewed by a sizeable audience.

In such an application setting, these teachings could then also accommodate the insertion of an advertisement for the winning bidder into the relevant corresponding content stream. By another approach, the insertion activity can be carried out by the winning bidder themselves, by the broadcasting network itself, by another third party who offers this particular service, or by any other means as may be available to meet such a need.

Those skilled in the art will also recognize that these teachings can be applied to achieve something of a reversed result. That is, advertising rates for aired commercials during a given item of audio-visual content can be dynamically reduced, during that airing, as a function (at least in part) of a failure to achieve a certain level of attention as measured by the aforementioned popularity information.

These teachings can also be leveraged to accommodate using 106 the popularity information to identify a particular content clip of interest. This, in turn, can lead to associating (107) such a content clip of interest with a network address (such as, but not limited to, a Uniform Resource Locator (URL) as is known in the art) that is specific to this particular content clip of interest. So configured, a given end user can then readily receive that particular content clip of interest by visiting that network address (for example, as streaming content, as a file download, or the like). In such a case, the aforementioned viewing recommendation can also include such a network address to permit the end user to immediately (or later, if they wish) visit that network address to see the content clip which instigated the popularity-based recommendation.

In such a case, the content clip itself can comprise an abridged version, or an otherwise edited version, of a specific content clip as may have been submitted by an end user as per these teachings. For example, a specific content clip can be formed by noting the average starting and stopping points as have been submitted by dozens, hundreds, or even thousands of end users as described above.

These teachings will also readily accommodate forming such a content clip for later retrieval by end users as an aggregation of a plurality of contents clips. By one approach in this regard, for example, a single aggregated content clip can comprise, in temporal sequence, the highlights of a particular sporting event by concatenating the popular content clips for that sporting event as have been otherwise identified by end users as per the above.

This step of using 106 the popularity information to identify a particular content clip of interest can also be taken in conjunction with other information and inputs as desired. For example, by one approach, a particular content clip can be formed as an automatic aggregated collection of a plurality of individual clips as were selected based, at least in part, upon end user selection criteria. To illustrate by way of example, a given end user may submit selection criteria comprising a given sports figure's name and a specific calendar date. The aforementioned network element can use this input to select relatively popular content clips from that date that feature this particular sports figure. This can serve, for example, to permit an end user to ultimately be provided with a network address which, when accessed, permits the end user to view a content clip that presents all of the highlighted plays that featured a favored player in a given game as was played on the day in question.

It would also be possible to combine these teachings with deeper and richer information to further characterize and enrich this sense of relative popularity. For example, by one approach, profile information regarding the end users who are providing the initial information regarding the content clips that serves as the basis for the popularity assessment can be utilized to further characterize the resultant popularity information. By this approach, for example, an end user might have access to histogram-based popularity information that indicates which content clips are not only popular, but that are popular with respect to a particular demographic audience of interest. This would permit, for example, a given end user to note that a particular content clip, while having only marginal relative popularity with respect to the overall viewing audience, is nevertheless rated quite highly by a group whose discerning input and opinion is important to this end user.

Some simple illustrative examples in this regard might include: (1) a particular content clip that is popular amongst fans of science fiction material; (2) a particular content clip that is popular amongst fans of a particular sports team; (3) a particular content clip that is popular amongst persons registered with a particular political party; and so forth.

This same notion of a histogram-based or like characterization can serve in other ways as well. For example, an end user can learn, via such a presentation modality, that a particular content clip, while not highly popular across all possible viewing choices at a given time, is nevertheless a most popular viewing choice within a particular viewing genre. To illustrate, a given clip may be the most popular clip from an item of audio-visual content comprising a science fiction program or offering, or from an item of audio-visual content comprising a nature-based program or offering, and so forth.

Referring momentarily to FIG. 3, an illustrative example of one possible presentation model 300 where a user can follow a set of trend-setting users or trusted friends to see what media they view as interesting is shown. In this example a timeline 301 across the bottom shows who is clipping when and how many clips. The end user can position their view selection on the timeline to see the specific user clips in the upper portion. Within the upper portion 301 the corresponding clip thumbnails are presented and when a clip is selected by highlighting, the client is presented the clip's description 303 along with associated metadata. This view presentation provides the client a pictorial presentation of which users may be the trend setters or which friends find certain programming interesting at a given point in time.

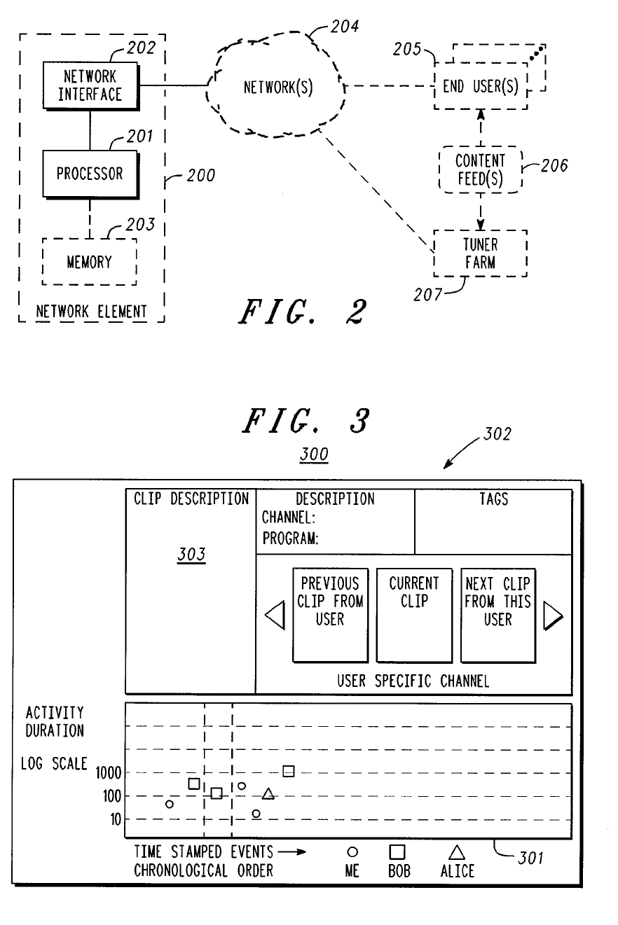

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, the network element 200 comprises, at least in part, a processor 201 that operably couples to a network interface 202. The processor 201 can also operably couple to a memory 203 as desired (and depending, to some extent, upon how much storage capacity is required by the network element 200 to carry out its specific functionality with respect, for example, to the storage of content clips of interest). The network interface 202 can be configured and arranged to at least receive, from a plurality of different end users 205 and via one or more intermediary networks 204 of choice, the aforementioned information regarding content clips as pertain to audio-visual content being provided from any of a plurality of content feeds (206) as noted above. The network interface 202 can also serve, as desired, to provide a means of interfacing with one or more tuner farms 207 as appropriate to a particular mode of functionality in accord with the present teachings.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize and appreciate that such a processor 201 can comprise a fixed-purpose hard-wired platform or can comprise a partially or wholly programmable platform. All of these architectural options are well known and understood in the art and require no further description here. In any event, such a processor 201 can be configured and arranged (via, for example, programming as is well within the capabilities of the skilled artisan) to carry out one or more of the aforementioned steps, actions, and/or functionality as are set forth here. This can comprise, for example, using the aforementioned received information regarding content clips as pertain to audio-visual content as well as the use of that information to automatically infer a corresponding relative popularity of such audio-visual content as corresponds to the content clips being so provided.

So configured, those skilled in the art will recognize and appreciate that these teachings provide a powerful, efficient, and effective mechanism for collecting, interpreting, and utilizing information regarding audio-video content. These teachings are highly scalable and, in fact, may provide particularly efficacious results as the number of end users and content feeds grows. These teachings are also readily leveraged to provide benefits to essentially all participants including the content providers, the content consumers, and supporting advertisers.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network element:
receiving, from a plurality of different end users, information regarding content clips as pertain to audio-visual content;
using the information to automatically infer a relative popularity of audio-visual content as corresponds to the content clips to provide popularity information.

2. The method of claim 1 wherein the audio-visual content comprises televised content.

3. The method of claim 1 wherein the information regarding content clips comprises at least one of:
a start time and a stop time for a given one of the content clips;
at least a portion of a given one of the content clips;
a content identifier.

4. The method of claim 1 wherein receiving, from a plurality of different end users, information regarding content clips as pertain to audio-visual content, comprises receiving at least some audio-visual content from a tuner farm.

5. The method of claim 1 further comprising:
receiving, from at least some of the plurality of different end users, tagging information regarding at least some of the content clips.

6. The method of claim 1 further comprising:
using the popularity information to form viewing recommendations.

7. The method of claim 6 further comprising:
providing the viewing recommendations to at least some of the plurality of different end users.

8. The method of claim 7 wherein providing the viewing recommendations to at least some of the plurality of different end users comprises providing a viewing recommendation for a first currently delivered viewing opportunity to an end user who is presently viewing a different viewing opportunity.

9. The method of claim 7 wherein providing the viewing recommendations to at least some of the plurality of different end users comprises, at least in part, providing a viewing recommendation in near time with respect to a transmission of the audio-visual content to which the viewing recommendation pertains.

10. The method of claim 1 further comprising:
using the popularity information to determine a price for advertising to be aired in conjunction with a selected item of audio-visual content.

11. The method of claim 10 wherein using the popularity information to determine a price for advertising to be aired in conjunction with a selected item of audio-visual content comprises, at least in part:
providing the popularity information to potential advertisers;
receiving bids from the potential advertisers regarding a price to be paid to air an advertisement in conjunction with the selected item of audio-visual content.

12. The method of claim 1 further comprising:
using the popularity information to identify a particular content clip of interest.

13. The method of claim 12 further comprising:
associating the particular content clip of interest with a network address such that an end user can readily receive the particular content clip of interest by visiting the network address.

14. The method of claim 13 wherein the particular content clip comprises an automatically aggregated collection of a plurality of individual clips as were selected based upon end user selection criteria.

15. The method of claim 13 wherein the network address comprises a Uniform Resource Locator (URL).

16. A network element comprising:
a network interface configured and arranged to receive, from a plurality of different end users, information regarding content clips as pertain to audio-visual content;
a processor operably coupled to the network interface and configured and arranged to use the information to automatically infer a relative popularity of audio-visual content as corresponds to the content clips to provide popularity information.

17. The network element of claim 16 wherein the information regarding content clips comprises at least one of:
a start time and a stop time for a given one of the content clips;
at least a portion of a given one of the content clips;
a content identifier.

18. The network element of claim 16 wherein the processor is further configured and arranged to use the popularity information to form viewing recommendations.

19. The network element of claim 16 wherein the processor is further configured and arranged to use the popularity information to determine a price for advertising to be aired in conjunction with a selected item of audio-visual content.

20. The network element of claim 16 wherein the processor is further configured and arranged to use the popularity information to identify a particular content clip of interest and to associate the particular content clip of interest with a network address such that an end user can readily receive the particular content clip of interest by visiting the network address.
